(19) United States
(12) Patent Application Publication
(10) Pub. No.: US 2011/0319699 A1
(43) Pub. Date: Dec. 29, 2011

(54) CARBONACEOUS RADIOACTIVE WASTE TREATMENT

(75) Inventor: Gérard Laurent, Villeurbanne (FR)

(73) Assignee: ELECTRICITE DE FRANCE, Paris (FR)

(21) Appl. No.: 13/255,280

(22) PCT Filed: Feb. 4, 2010
(86) PCT No.: PCT/FR2010/050174

§ 371 Date: Sep. 8, 2011

Related U.S. Application Data
(63) Continuation-in-part of application No. 12/437,195, filed on May 7, 2009.

(30) Foreign Application Priority Data
Mar. 11, 2009 (FR) 09 51517

(51) Int. Cl. G21F 9/32; G21C 1/00; G21F 9/30

(52) U.S. Cl. 588/19; 588/18; 422/159

(57) ABSTRACT

The invention relates to the treatment of carbon-containing radioactive waste. It particularly envisages:

a first type of waste treatment to obtain a carbon oxide, and

a second type of treatment to obtain a solid precipitate of the carbon oxide by reacting with a selected element.

A method according to the invention comprises:

a first phase during which both the first and second type of treatment are applied, and

a second phase during which only the first type of treatment is applied.

The invention relates to the treatment of carbonaceous radioactive waste, such as for example graphite structures (“sleeves” surrounding nuclear fuel assemblies, or “bricks” used as a reflector or a moderator) or organic resins (frequently in bead or pellet shape) used to trap other radioactive waste particularly in nuclear power plant reactors.

In such carbonaceous waste, it is sought to perform the isolation and confined storage of volatile radionuclides, such as tritium (³H), chlorine 36 (³⁶Cl), and especially carbon isotopes, particularly the radioactive isotope ¹⁴C (hereinafter referred to as “carbon 14”).

Two types of treatment of said carbonaceous waste are thus envisaged:
a first type of treatment to obtain a carbon oxide, for example carbon monoxide and/or dioxide wherein the carbon element is the carbon 14 isotope, and
a second type of treatment of said carbon oxide to obtain a solid precipitate by reacting with a selected element such as calcium, for example.

This second type of treatment, referred to as “carbonation”, consists for example of bubbling the carbon oxide in a solution containing quick lime (when the selected element is calcium) and the solid precipitate obtained (typically calcite CaCO₃ wherein the carbon element is the isotope ¹⁴C) may be confined and stored on a long-term basis in bulk in containers stored on the surface or underground under a specific thickness of ground, for example under a hill. It is specified in this case that an alternative consists of reacting the carbon oxide with an element other than calcium, such as magnesium (or other metals), to obtain magnesite MgCO₃. Therefore, it should be noted that the aim of this second type of treatment is to generally obtain an insoluble solid precipitate of carbonates and/or of salts, comprising the carbon element.

Usually, the second type of treatment is applied to all the carbon oxide resulting from the first treatment. A solid precipitate is thus obtained from all the carbon oxide resulting from the waste treatment.

This solution is not very satisfactory for at least two reasons. Firstly, the packaging, storage and burial of the solid precipitate (calcite or other) are very costly. Secondly, in order to respect the environment, it is sought to need to store the least amount of waste possible (especially if said waste is suitable for destruction or treatment).

The present invention aims to improve the situation.

To this end, it firstly proposes a method comprising:
a first phase during which both the first and the second type of treatment are applied, and
a second phase during which only the first type of treatment is applied.

Indeed, it has been observed that the radioactive isotope ¹⁴C, probably due to the nature of the atomic bonds thereof having different properties to those of non-radioactive carbon ¹²C and possibly to those of the other isotope ¹³C (which is harmless or relatively harmless) tends to react more rapidly than other carbon isotopes during the application of the first type of treatment.

An explanation of this effect is given hereafter. In a reactor, in a flow of thermal neutrons, two reactions may be the cause of the isotope ¹⁴C:
a first reaction ¹³C(n,γ): ¹⁴C and
a second reaction ¹⁴N(n,p): ¹⁴C.

The first reaction is predominant with regard to the second as carbon forms predominantly the graphitic matrix while nitrogen is mainly present in the graphite's pores.

Calculus have shown that the recoil energy for the isotope ¹⁴C, coming from the two types of reactions, are big enough to break chemical links inside the graphene plans forming the graphite's structure. Indeed, the binding energy is mostly greater than 1 keV (for the isotope ¹⁴C formed from the isotope ¹³C) and of roughly 40 keV (for the isotope ¹⁴C formed from the isotope ¹⁴N). Therefore there is a great probability that C—C bonds of the graphene plans, whose binding energy approaches 280 eV, are broken, especially for the atoms of the isotope ¹⁴C, and these atoms are displaced from their structural location. In a reactor, these atoms may form new bonds with some other carbon atoms or with some impurities inside the graphite, however the working temperatures of the reactor are not high enough to form again graphene plans.

Thus, the isotope ¹⁴C is freed before to the isotope ¹²C, during the first and/or second treatments cited above.

In other words, in the first waste oxidation treatment phase, carbon oxide wherein the carbon element has a higher concentration of the radioactive isotope ¹⁴C is firstly essentially released; it is followed by carbon oxide wherein the carbon element has low or no radioactivity as it essentially consists of ¹²C. It is then understood that this non-radioactive carbon oxide can be discharged directly into the atmosphere, without having to be treated to obtain a solid precipitate.

In more generic terms, in the method according to the invention where the carbonaceous waste initially comprises carbon 14, the solid precipitate obtained following the first phase essentially comprises carbon 14, whereas the carbon oxide from the second phase does not comprise carbon 14 or only comprises a residual amount thereof, and is therefore acceptable for direct discharge. The carbon oxide from the second phase may thus be discharged freely into the atmosphere (or may be formed for example by being oxidized in carbon dioxide to prevent carbon monoxide from being discharged into the atmosphere).

The favorable time to switch from the first phase to the second phase and thus discharge the carbon oxide into the atmosphere may be determined as follows:

a quantity of radioactivity in the carbon oxide obtained following the application of the first type of treatment in the first phase is measured, and

it is decided to apply the second phase if the quantity of radioactivity is less than a selected threshold.

However, in order to complete such an embodiment, it is necessary to ensure that only the carbon oxide is liable to be radioactive in the first treatment phase. Yet, the waste to be treated may comprise other elements than carbon, said non-carbonaceous volatile elements being radioactive, such as, for example tritium (³H) or chlorine isotope 36 (³⁶Cl), or others. In a standard, but advantageous configuration in the context of the invention, the waste is crushed and routed by means of a wet process and the non-carbonaceous radioactive elements are confined and treated in the wet process, whereas the carbon oxide is extracted from the wet process in volatile form. It is thus advantageous to use a suitably positioned radioactivity analyzer. In this instance, the quantity of radioactivity in the carbon oxide is advantageously measured using such an analyzer, arranged outside the wet process. This analyzer can typically measure the β activity on carbon 14 possibly comprised in the carbon oxide emanations from the first type of treatment.

It is specified here that the purpose of the abovementioned “first type of treatment” aims at degrading the waste to obtain a carbon oxide, typically monoxide CO or dioxide CO₂. In the field of radioactive waste treatment, several ways to obtain a carbon oxide are known:

by means of steam reforming, as described in the document US 2002/064251,

or by means of roasting in inert gas.

Steam reforming is a treatment based on superheated steam, according to a reaction whereby C+H₂O→CO+H₂, which preferentially takes place at a temperature greater than or of the order of 900° C., and preferentially in the context of the invention at 1200° C. or over, as seen below.

Roasting in inert gas (for example in nitrogen N₂) is also preferentially performed at a temperature greater than or of the order of 900° C., and preferentially in the context of the invention at 1200° C. or over, according to a reaction whereby:

C+½ O₂→CO and/or C+O₂→CO₂ and/or the same reaction as above

C+H₂→CO+H₂ with water obtained from the wet process (in aqueous medium).

In the context of the invention, it is particularly sought to implement these reactions at a temperature greater than 900° C. (which is the temperature usually used for these reactions) as it was observed, as described in detail hereinafter with reference to FIG. 2, that the effect whereby carbon 14 reacts before the non-radioactive carbon ¹²C to form the oxide CO or CO₂ proved to be increasingly marked as the reaction temperature (or more generally that of the carbonaceous waste) increased. In this case, furnaces capable to exceeding said temperature of 900° C. are preferentially used, in a waste treatment facility for the implementation of the method according to the invention.

Thus, in addition to or as an alternative to the use of a radioactivity analyzer on the carbon oxide generated during the first phase, it may be advantageous to also have charts to determine, according to the oxidation reaction temperature, the time at which the carbon oxide emanations can be released into the open air. Therefore, in such an embodiment, it is possible to switch from the first phase to the second phase at a time selected according to at least:

an initial amount of the waste to be treated, and

an oxidation reaction temperature, during the application of the first type of treatment.

Furthermore, it is advantageous to start the carbon oxidation treatment by:

roasting (by applying carbonation to the carbon oxide obtained, without releasing into the open air in this case), and

continuing the waste treatment with steam reforming (by applying carbonation only for a selected length of time, before discharging the remaining carbon oxide freely into the atmosphere).

Thus, in more generic terms, the first type of treatment comprises, in the first phase, roasting in inert gas and, in the first and second phases, steam reforming.

The present invention also relates to a facility for the treatment of carbonaceous radioactive waste, said facility comprising means for the implementation of the method according to the invention. These means are described in detail hereinafter.

Moreover, other features and advantages of the invention will emerge on studying the detailed description hereinafter, and the appended drawings wherein:

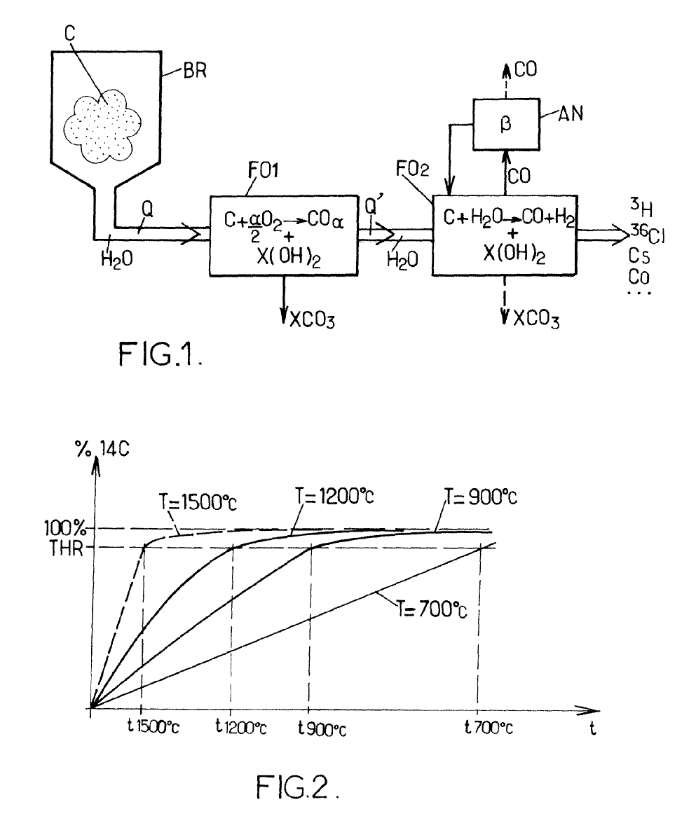

FIG. 1 illustrates schematically a facility for the treatment of waste according to the invention, and

FIG. 2 illustrates different variations of the percentage of carbon 14 having reacted in an oxide form as a function of time, for different respective reaction temperatures.

Reference is first made to FIG. 1 wherein a crusher BR crushes graphite (with a grain size typically of the order of one centimeter), under water. An amount Q of carbonaceous waste is routed via a wet process (H₂O) to a first furnace, in this case for roasting, for a first “under inert gaz” oxidation operation, preferentially at a temperature of 1200° C. In the furnace FO1, the reaction operation may be as follows:

C+α/2 O2→CO_{α},

where α=1 or 2.

A carbonation reaction such as the following is then applied:

X(OH)₂+CO₂→XCO₃+H₂O, where X=Ca, or Mg, or other, for example by bubbling in lime water (where X=Ca).

In this case, it is specified that a possible alternative to carbonation consists of applying an isotopic separation of the carbon, as described in the document JP 2000 070678.

However, carbonation is preferred in this case as, producing calcite from lime water (X=Ca) only produces a few m³ of carbonate a year, which can be stored on a long-term basis (for example buried under a selected site). In this step, approximately 30% of the carbon 14 comprised in graphite waste is already treated. Furthermore, 80% of tritium is also treated in this step. The roasting step may optionally be repeated on several cycles in order to drain the waste originating from the carbon 14 suitable for decontamination as much as possible during this roasting step.

An additional amount Q′ (where Q′=αQ where α<1) is routed, again in a wet process H₂O, to a second furnace FO2, for the implementation of the invention per se. In this second furnace FO2 a steam reforming reaction is applied, which consists of producing the following reaction:

C+H₂O→CO+H₂

This reaction is preferentially conducted in this case at 1200° C. or over, using a superheated steam injection. The carbon oxide is then collected, in a first phase, for a reaction in order to obtain a carbonate precipitate XCO₃ (for example with lime water, where X=Ca). It is specified that, by means of the method according to the invention, the amount of carbonate, in the form of solid waste to be buried under a hill, is merely a few 100 m³/year, by optimizing the time when it is possible to discontinue carbonation to switch to the second phase where the carbon oxide (in gas form) is discharged directly into the atmosphere.

In particular, in one embodiment of the invention, a β radiation analyzer, outside the wet process, detects the presence of carbon 14 in the carbon oxide emanations. If the analyzer AN detects carbon 14 below a given threshold THR (for example of the order of 1%) in the carbon oxide emanations, then the carbon oxide emanations may be discharged directly into the atmosphere, and the carbonation operation may be discontinued.

This measurement outside the wet process is advantageous in that other radioactive elements from the waste, to be treated, remain confined in the wet process and are not extracted in said steam reforming step. This is particularly the case of tritium ³H, and ³⁶Cl, liable to emit β radiation but which remain confined in the wet process, such that the analyzer AN does not detect the radiation thereof and only detects the radiation from the carbon 14 in the fumes, enabling a real-time measurement of the time of switchover from the first carbonation phase to the second free discharge phase.

Finally, radioactive elements in the waste, other than carbon 14 (particularly tritium, chlorine 36, cesium, cobalt, iron and other metals) are treated in the wet process and trapped therein to be eventually collected and stored on a long-term basis.

With reference to FIG. 2, the benefit of performing the roasting operation (with several cycles if required) and more specifically the steam reforming operation at a high temperature with respect to the temperatures according to the prior art (which are frequently approximately 900° C., or less than 900° C.) is now explained.

The inventor observed, for the first time to the knowledge thereof, that carbon 14 reacted as a majority before the other isotopes of carbon, as well during the roasting reaction as during the steam reforming reaction. This effect is very probably due to the nature of the atomic bonds of carbon 14, compared to the other isotopes. The effect is increasingly marked as the oxidation reaction temperature increases. Thus, with reference to FIG. 2, it indeed appears that the curves representing the percentage of carbon 14 already having reacted are substantially convex in shape (since carbon 14 reacts before the other isotopes, as a majority) and, above all, the convexity of the curves is increasingly marked as the reaction temperature increases. Thus, rather than react all the carbon oxide to produce carbonates suitable for bulk storage, a threshold THR, above which the amount of carbon 14 liable to be released into the atmosphere in the form of gaseous carbon oxide is negligible or, at least, tolerated by the authorities in view of the sanitary and environmental impact thereof, is defined.

This threshold THR is reached much more quickly if the reaction temperature is high, as shown in FIG. 2. Thus, reaction temperatures in the furnace FO2 of the order of 1200° C. are preferred, compared to the prior art where it was known to apply rather a temperature of 900° C. If allowed by furnaces in the future, an even higher temperature, for example 1500° C., would be particularly advantageous. In any case, it is noted that the time t_{1200° C.} at which the method can switch from the carbonation phase to the free carbon oxide emanation discharge phase is much shorter for high temperatures than for low temperatures.

In addition, it is important to note that the convex course of the curves of the percentage of carbon having reacted in oxide form, as a function of time, is also observed both for the roasting and steam reforming oxidation reactions.

However, in principle, in the roasting step in the furnace FO1, free discharge of the carbon oxide emanations is not envisaged. Thus, a switchover to the second free discharge phase is not envisaged, as this operation is reserved for the steam reforming treatment, in the example described herein.

Naturally, the present invention is not restricted to the embodiment described above as an example; it extends to other alternative embodiments.

For example, the method for trapping tritium or chlorine 36 has not been described in detail in the method described above with reference to FIG. 1, being understood that the invention relates rather to the treatment of carbon 14 in carbonaceous waste. Nevertheless, it was observed that these elements remain trapped in the water from the wet process.

Moreover, the roasting step, per se, may involve a plurality of reactions such as C+α/2 O₂→CO_{α}, where α=1 or 2, or also C+H₂O→CO+H₂, but all leading to carbon oxidation, as a general rule. The water (H₂O) involved in the latter reaction above may be obtained from the wet process (in residual form or not). It should finally be noted that, unlike the steam reforming step where superheated steam is voluntarily injected onto the waste, the roasting step simply degrades the waste by means of oxidation, this being performed at a high temperature (approximately 1200° C. or over). It should also be noted that it is advantageous to conduct this roasting step by applying several cycles.

1. A method for treatment of carbonaceous radioactive waste, comprising:
a first type of waste treatment to obtain a carbon oxide, and
a second type of treatment to obtain a solid precipitate of the carbon oxide by reacting with a selected element,
wherein it further comprises:
a first phase during which both the first and the second type of treatment are applied, and
a second phase during which only the first type of treatment is applied.

2. The method according to claim 1, wherein the carbon oxide obtained from the second phase is formed to be discharged freely into the atmosphere.

3. The method according to claim, wherein:
the selected element is calcium,
the second type of treatment is a carbonation, and
the solid precipitate from the first phase is calcite, intended to be packaged for long-term storage.

4. The method according to claim 1, wherein:
a quantity of radioactivity in the carbon oxide obtained following the application of the first type of treatment in the first phase is measured, and
it is decided to apply the second phase if the quantity of radioactivity is less than a selected threshold.

5. The method according to claim 4, wherein, the waste comprising radioactive non-carbonaceous elements, the waste is crushed and routed by means of a wet process and the non-carbonaceous radioactive elements are confined and treated in the wet process, whereas the carbon oxide is extracted from the wet process in a volatile form, and the quantity of radioactivity in the carbon oxide is measured using an analyzer arranged outside the wet process.

6. The method according to claim 1, wherein the first type of treatment comprises at least one steam reforming operation.

7. The method according to claim 1, wherein the first type of treatment comprises, in the first phase, a roasting in inert gas.

8. The method according to claim 1, wherein it is selected to switch from the first phase to the second phase at a time selected as a function of at least:
an initial amount of waste to be treated, and
an oxidation reaction temperature, during the application of the first type of treatment.

9. The method according to claim 8, wherein said temperature is greater than 900° C., and preferentially of the order of 1200° C.

10. The method according to claim 1, wherein, the carbonaceous waste initially comprising carbon 14, the solid precipitate obtained following the first phase essentially comprises carbon 14, whereas the carbon oxide obtained from the second phase only comprises a residual amount of carbon 14.

11. The method according to claim 1, wherein said carbonaceous waste comprises at least graphite and/or resins.

12. A carbonaceous radioactive waste treatment facility, wherein it comprises means for conducting the method according to claim 1.
